(19) United States
(12) Patent Application Publication
(10) Pub. No.: US 2014/0134974 A1
(43) Pub. Date: May 15, 2014

(54) METHOD AND APPARATUS FOR REPORTING CHARGING INFORMATION OF DIRECT DEVICE TO DEVICE COMMUNICATION IN A WIRELESS COMMUNICATION SYSTEM

(71) Applicant: INNOVATIVE SONIC CORPORATION, Taipei City (TW)

(72) Inventor: Richard Lee-Chee Kuo, Taipei City (TW)

(73) Assignee: INNOVATIVE SONIC CORPORATION, Taipei City (TW)

(21) Appl. No.: 14/077,842

(22) Filed: Nov. 12, 2013

Related U.S. Application Data
(60) Provisional application No. 61/725,195, filed on Nov. 12, 2012.

(51) Int. Cl. H04W 4/24; H04M 15/00

(52) U.S. Cl. CPC H04W 4/24; H04M 15/67
USPC 455/406

(57) ABSTRACT

A method and apparatus are disclosed for reporting charging information by a first user equipment. The method includes establishing, by the first user equipment, a radio resource control (RRC) connection with a network and entering a RRC connection mode. The method further includes establishing, by the first user equipment, a peer to peer connection with a second user equipment for a proximity-based service (ProSe) communication. In addition, the method includes sending, by the first user equipment, charging information of the ProSe communication to the network.

### CROSS-REFERENCE TO RELATED APPLICATIONS

The present Application claims the benefit of U.S. Provisional Patent Application Ser. No. 61/725,195 filed on Nov. 12, 2012, the entire disclosure of which is incorporated herein by reference.

### FIELD

This disclosure generally relates to wireless communication networks, and more particularly, to methods and apparatuses for direct device to device communication in a wireless communication system.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure for which standardization is currently taking place is an Evolved Universal Terrestrial Radio Access Network (E-UTRAN). The E-UTRAN system can provide high data throughput in order to realize the above-noted voice over IP and multimedia services. The E-UTRAN system's standardization work is currently being performed by the 3GPP standards organization. Accordingly, changes to the current body of 3GPP standard are currently being submitted and considered to evolve and finalize the 3GPP standard.

### SUMMARY

A method and apparatus are disclosed for reporting charging information by a first user equipment. The method includes establishing, by the first user equipment, a radio resource control (RRC) connection with a network and entering a RRC connection mode. The method further includes establishing, by the first user equipment, a peer to peer connection with a second user equipment for a proximity-based service (ProSe) communication. In addition, the method includes sending, by the first user equipment, charging information of the ProSe communication to the network

### BRIEF DESCRIPTION OF THE DRAWINGS

FIG. 1 shows a diagram of a wireless communication system according to one exemplary embodiment.

FIG. 2 is a block diagram of a transmitter system (also known as access network) and a receiver system (also known as user equipment or UE) according to one exemplary embodiment.

FIG. 3 is a functional block diagram of a communication system according to one exemplary embodiment.

FIG. 4 is a functional block diagram of the program code of FIG. 3 according to one exemplary embodiment.

FIG. 5 is a diagram of peer to peer connections in a cell according to one exemplary embodiment.

FIG. 6 is a message sequence chart according to one exemplary embodiment.

### DETAILED DESCRIPTION

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3GPP LTE (Long Term Evolution) wireless access, 3GPP LTE-A or LTE-Advanced (Long Term Evolution Advanced), 3GPP2 UMB (Ultra Mobile Broadband), WiMax, or some other modulation techniques.

In particular, the exemplary wireless communication systems devices described below may be designed to support one or more standards such as the standard offered by a consortium named “3rd Generation Partnership Project” referred to herein as 3GPP, including Document Nos. SP-110638, “WID on Proposal for a study on Proximity-based Services”, TR 22.803-100, “Feasibility Study for Proximity Services (ProSe)”, and 3GPP TS 23.060-b10 (2012-03), “General Packet Radio Service (GPRS) service description Stage 2 (Release 11).” The standards and documents listed above are hereby expressly incorporated herein.

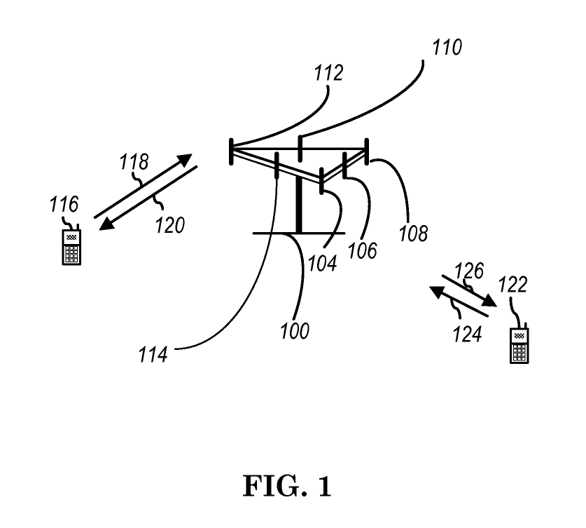

FIG. 1 shows a multiple access wireless communication system according to one embodiment of the invention. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal 116 (AT) is in communication with antennas 112 and 114, where antennas 112 and 114 transmit information to access terminal 116 over forward link 120 and receive information from access terminal 116 over reverse link 118. Access terminal (AT) 122 is in communication with antennas 106 and 108, where antennas 106 and 108 transmit information to access terminal (AT) 122 over forward link 126 and receive information from access terminal (AT) 122 over reverse link 124. In a FDD system, communication links 118, 120, 124 and 126 may use different frequency for communication. For example, forward link 120 may use a different frequency then that used by reverse link 118.

Each group of antennas and/or the area in which they are designed to communicate is often referred to as a sector of the access network. In the embodiment, antenna groups each are designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage causes less interference to access terminals in neighboring cells than an access network transmitting through a single antenna to all its access terminals.

An access network (AN) may be a fixed station or base station used for communicating with the terminals and may also be referred to as an access point, a Node B, a base station, an enhanced base station, an eNodeB, or some other terminology. An access terminal (AT) may also be called user equipment (UE), a wireless communication device, terminal, access terminal or some other terminology.

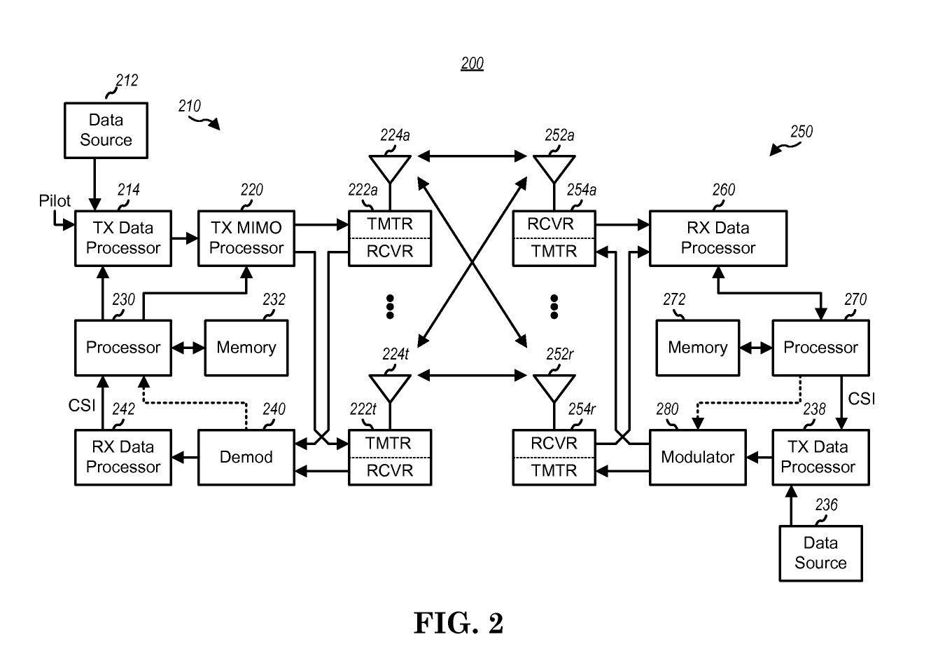

FIG. 2 is a simplified block diagram of an embodiment of a transmitter system 210 (also known as the access network) and a receiver system 250 (also known as access terminal (AT) or user equipment (UE)) in a MIMO system 200. At the transmitter system 210, traffic data for a number of data streams is provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QPSK, M-PSK, or M-QAM) selected for that data stream to provide modulation symbols. The data rate, coding, and modulation for each data stream may be determined by instructions performed by processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

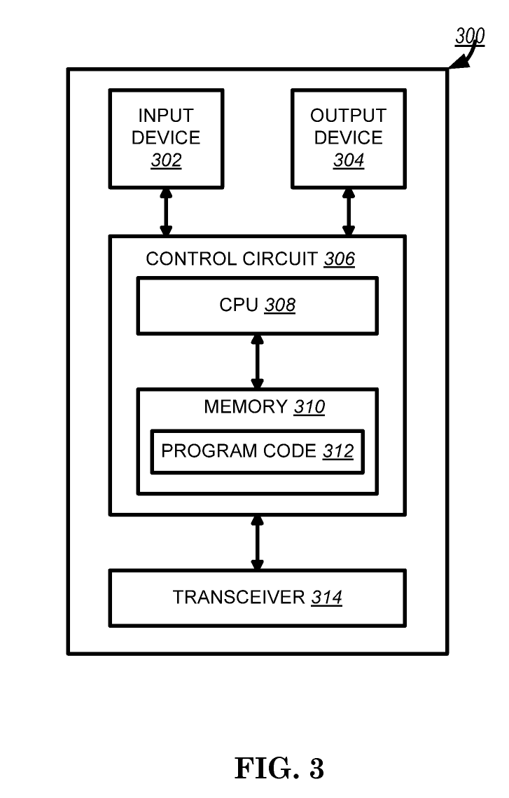

Turning to FIG. 3, this figure shows an alternative simplified functional block diagram of a communication device according to one embodiment of the invention. As shown in FIG. 3, the communication device 300 in a wireless communication system can be utilized for realizing the UEs (or ATs) 116 and 122 in FIG. 1, and the wireless communications system is preferably the LTE system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly.

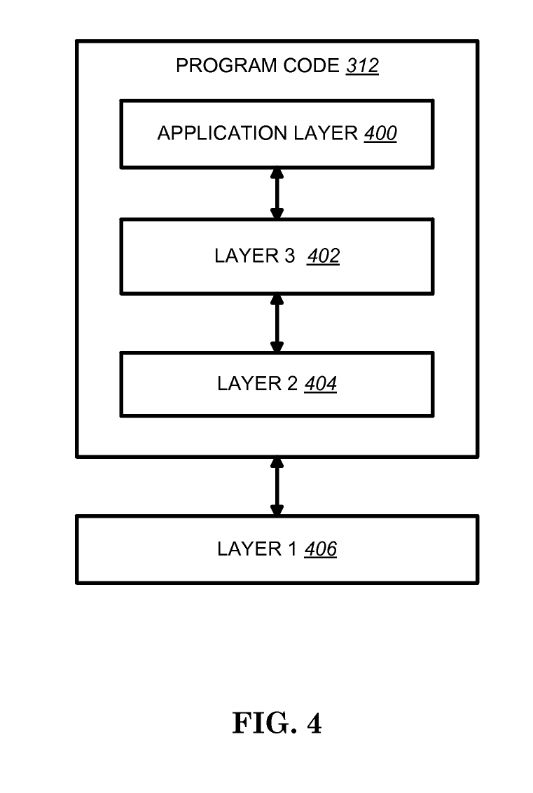

FIG. 4 is a simplified block diagram of the program code 312 shown in FIG. 3 in accordance with one embodiment of the invention. In this embodiment, the program code 312 includes an application layer 400, a Layer 3 portion 402, and a Layer 2 portion 404, and is coupled to a Layer 1 portion 406. The Layer 3 portion 402 generally performs radio resource control. The Layer 2 portion 404 generally performs link control. The Layer 1 portion 406 generally performs physical connections.

For LTE or LTE-A systems, the Layer 2 portion may include a Radio Link Control (RLC) layer and a Medium Access Control (MAC) layer. The Layer 3 portion may include a Radio Resource Control (RRC) layer.

3GPP SP-110638 proposes a new study item on proximity-based services (ProSe). The justification and objective of this study item are quoted below:

Justification

Proximity-based applications and services represent a recent and enormous socio-technological trend. The principle of these applications is to discover instances of the applications running in devices that are within proximity of each other, and ultimately also exchange application-related data. In parallel, there is interest in proximity-based discovery and communications in the public safety community.
Current 3GPP specification are only partially suited for such needs, since all such traffic and signaling would have to be routed in the network, thus impacting their performance and adding un-necessary load in the network. These current limitations are also an obstacle to the creation of even more advanced proximity-based applications.
In this context, 3GPP technology, has the opportunity to become the platform of choice to enable proximity-based discovery and communication between devices, and promote a vast array of future and more advanced proximity-based applications.

Objective

The objective is to study use cases and identify potential requirements for an operator network controlled discovery and communications between devices that are in proximity, under continuous network control, and are under a 3GPP network coverage, for:

1. Commercial/social use

2. Network offloading

3. Public Safety

4. Integration of current infrastructure services, to assure the consistency of the user experience including reachability and mobility aspects

Additionally, the study item will study use cases and identify potential requirements for

5. Public Safety, in case of absence of EUTRAN coverage (subject to regional regulation and operator policy, and limited to specific public-safety designated frequency bands and terminals)

Use cases and service requirements will be studied including network operator control, authentication, authorization, accounting and regulatory aspects. p The study does not apply to GERAN or UTRAN.

3GPP TR 22.803-100 captures the feasibility study for proximity-based services (ProSe). In addition to some use cases of the proximity-based services, this document also describes additional charging requirements and security requirements as quoted below:

Additional Charging Requirements

When a ProSe-enabled UE uses ProSe Communication, the operator shall be able to collect accounting data for ProSe communication including:

activation/deactivation of the ProSe Communication feature

ProSe Communication initiation/termination

ProSe Communication duration, and amount of data transferred

The above requirements do not apply to public safety communications outside network coverage.

Additional Security Requirements

The system shall ensure that ProSe is secure.
The system shall ensure that ProSe Discovery respects privacy.
The system shall ensure the validity of the ProSe Discovery information provided to the discoverer. The system shall be able to provide security comparable to that provided for the current 3GPP system for ProSe Communications, reusing existing 3GPP security mechanisms whenever possible and appropriate.
The system shall be able to restrict ProSe Discovery information to the ProSe-enabled UEs that have been authorized.
Editor's Note: Between which parties authorization is required (user/device/application/operator etc.) is FFS.

In the prior art, such as U.S. Patent Application Publication No. 20090232142, a wireless terminal establishes a peer-to-peer connection with another wireless terminal by monitoring a connection identifier (CID) broadcast channel and negotiating with each other via paging signaling to determine a CID for this connection. After the peer-to-peer connection is established, either party of the connection may signal its transmit request at a scheduling resource (e.g. traffic transmission request/request response resource) associated with the CID if it has information for transmission. Information may then be transmitted at the following data segment resource if transmission is allowed for this connection. In addition, a wireless terminal starts to signal presence of the CID on the CID broadcast channel when the peer to peer connection is established.

According to 3GPP TS 23.060-b10, charging information is collected for each wireless terminal by Serving GPRS Support Nodes (SGSNs) and Gateway GPRS Support Nodes (GGSNs) that serving the wireless terminal. The information that the operator uses to generate a bill to a subscriber is operator-specific and every operator collects and processes his own charging information. This 3GPP specification specifies, as a minimum, that the SGSN shall collect the following charging information:

usage of the radio interface: the charging information shall describe the amount of data transmitted in Mobile-originated and Mobile-terminated directions categorized with Quality of Service (QoS) and user protocols;

usage of the general GPRS resources: the charging information shall describe the usage of other GPRS-related resources and the MS's network activity (e.g. mobility management); and location of MS: HPLMN, VPLMN, plus optional higher-accuracy location information.

And, as a minimum, the GGSN shall collect the following charging information:

destination and source: the charging information shall describe the destination and source addresses with a level of accuracy as defined by the GPRS operator;

usage of the packet data networks: the charging information shall describe the amount of data sent and received to and from the packet data network; and

usage of the packet data protocol addresses: the charging information shall describe how long the MS has used the PDP addresses.

According to 3GPP TS 23.060-b10, the network collects charging information for the current mobile packet transfer system. GGSNs and SGSNs may monitor signaling and data transferred in the system to collect charging information with respect to a UE.

When the peer to peer ProSe communication is introduced into the current mobile packet transfer system, how to collect the charging information for the ProSe communication should be considered.

For a ProSe communication, in principle, the network nodes (e.g. eNBs) can still monitor signaling and data of each peer to peer connection on the air to collect the charging information. However, this may not be feasible due to the following reasons:

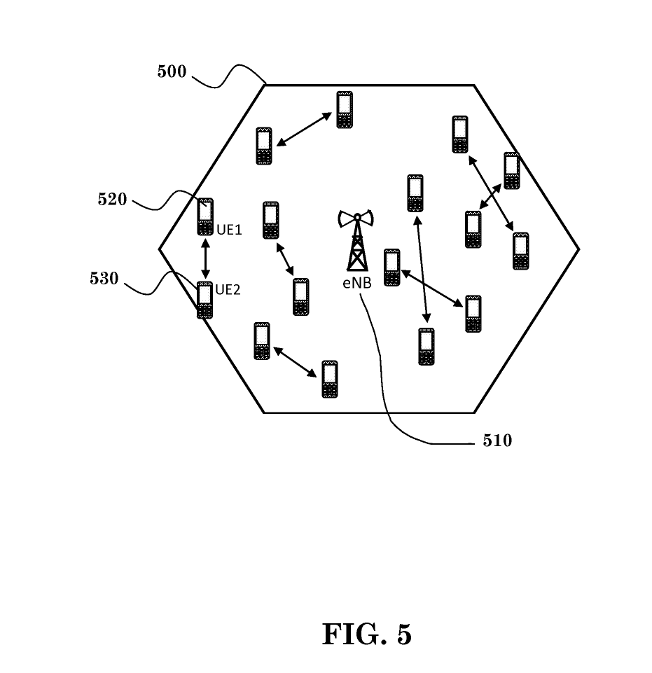

(1) The power of a ProSe communication should be set to reach the other party of a connection and not to cause severe interference to other connections. Thus, the power should be kept small enough. As a result, it may not be able to reach the eNB if the peer parties are close to each other and far from the eNB e.g. UE1 and UE 2 in FIG. 5, which shows several peer to peer connections in a cell.

(2) In the environment of a ProSe communication system (e.g. a mall), it is very likely that there could be buildings or obstacles to block the radio signals from the eNB.

Therefore, it may be necessary for the UE to send charging information of a ProSe communication to the network. The charging information may be sent when the peer to peer connection is released or when it is requested by the network.

Alternatively, an indicator included in system information of the network may indicate whether or not a UE should send the charging information.

According to 3GPP TR22.803, the ProSe communication system shall ensure ProSe is secure. Thus, it can be expected the network needs to be involved in a peer to peer connection establishment to set up the security configuration for a ProSe communication. So, a peer to peer connection should be established when the concerned UE is in the RRC connected mode. In this situation, both the RRC connection and the peer to peer connection exist at the same time. This allows a UE to send charging information of a ProSe communication to the network via the RRC connection.

In the environment of a mall (or other enclosed environments), the radio link between the UE and the eNB may fail, resulting in RRC connection release. However, the peer to peer connection may still be available because of short distance between two parties of this connection. In this situation, it is reasonable for the UE to release the peer to peer connection when the RRC connection is released because the network cannot collect charging information from the UE in RRC idle mode. However, this would dissatisfy the user, especially when the ProSe communication is still available.

A compromise would be allowing the ProSe communication to continue in the RRC idle mode and requesting the UE to report charging information of the ProSe communication to the network next time when a new RRC connection is established.

FIG. 5 is a diagram of peer to peer connections in a cell 500 according to one exemplary embodiment. As shown in FIG. 5, the cell 500 includes a network node 510 such as an evolved Node B (eNB). The cell also includes a plurality of user equipment (UE). As shown in FIG. 5, a first UE 520 is connected to a second UE 530. Additionally, other UEs within the cell may be connected to each other. The connected UE's may be close or far in proximity within the cell 500 as shown in FIG. 5.

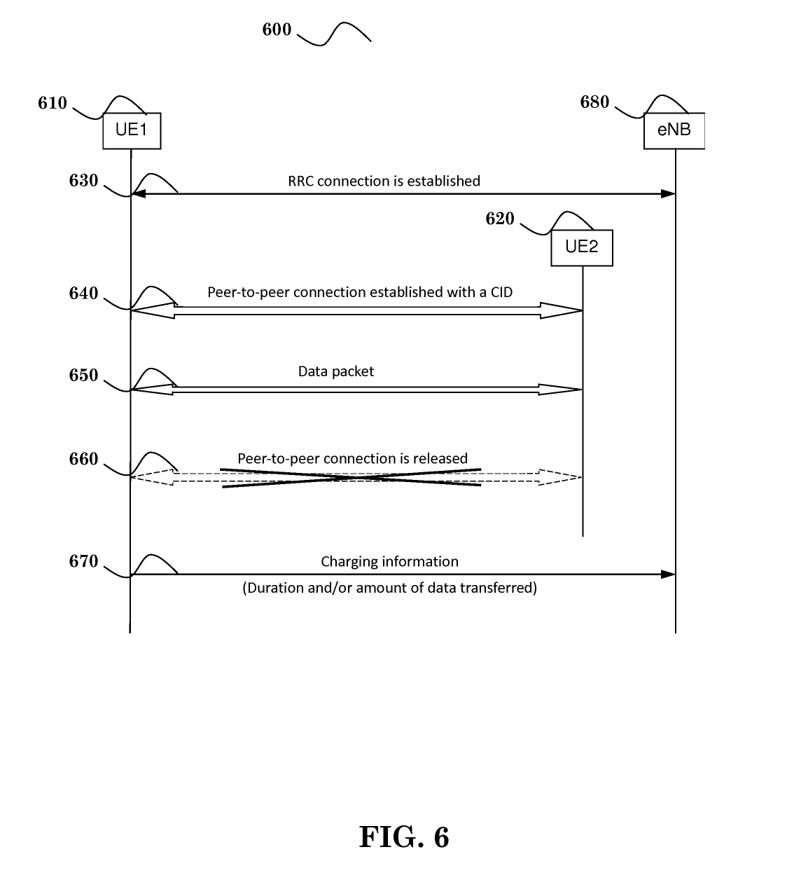

FIG. 6 is a message sequence chart 600 according to one exemplary embodiment. As shown in FIG. 6, in step 630, a first UE 610 establishes a RRC connection with an eNB 680. At step 640, a peer-to-peer connection between the first UE 610 and the second UE 620 is established with a CID. One or more data packets may be exchanged between the first UE 610 and the second UE 620 at step 650. The peer-to-peer connection is released at step 660. The charging information is sent from the first UE 610 to the eNB 680 at step 670.

In one embodiment, the first user equipment establishes a radio resource control (RRC) connection with a network and enters a RRC connection mode. The first user equipment also establishes a peer to peer connection with a second user equipment for a proximity-based service (ProSe) communication. The first user equipment releases the RRC connection and entering a RRC idle mode. Later, the first user equipment also releases the peer to peer connection during the RRC idle mode. The first user equipment sends charging information of the ProSe communication to the network after the first user equipment establishes a new RRC connection with the network.

In one embodiment, the first user equipment sends the charging information when the peer to peer connection is released. In another embodiment, the first user equipment sends the charging information in response to a request message received from a network node (e.g., eNB—“evolved Node B”). The charging information may contain a duration of the ProSe communication or an amount of data transferred during the ProSe communication. In another embodiment, a data path of the peer to peer connection goes directly between the first user equipment and the second user equipment without via any network node.

In another embodiment, the first user equipment determines whether to send the charging information to the network based on an indicator included in system information of the network. The indicator may indicate if the charging information should be reported by a user equipment.

Referring back to FIGS. 3 and 4, the device 300 includes a program code 312 stored in memory 310. In one embodiment, the CPU 308 could execute the program code 312 (i) to establish, by the first user equipment, a radio resource control (RRC) connection with a network and entering a RRC connection mode, (ii) to establish, by the first user equipment, a peer to peer connection with a second user equipment for a proximity-based service (ProSe) communication, and (iii) to send, by the first user equipment, charging information of the ProSe communication to the network. In one embodiment, the program code 312 also determines whether to send the charging information to the network based on an indicator included in system information of the network.

In addition, the CPU 308 can execute the program code 312 to perform all of the above-described actions and steps or others described herein.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. As an example of some of the above concepts, in some aspects concurrent channels may be established based on pulse repetition frequencies. In some aspects concurrent channels may be established based on pulse position or offsets. In some aspects concurrent channels may be established based on time hopping sequences. In some aspects concurrent channels may be established based on pulse repetition frequencies, pulse positions or offsets, and time hopping sequences.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects any suitable computer-program product may comprise a computer-readable medium comprising codes relating to one or more of the aspects of the disclosure. In some aspects a computer program product may comprise packaging materials.

While the invention has been described in connection with various aspects, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

1. A method for reporting charging information by a first user equipment, the method comprising:
establishing, by the first user equipment, a radio resource control (RRC) connection with a network and entering a RRC connection mode;
establishing, by the first user equipment, a peer to peer connection with a second user equipment for a proximity-based service (ProSe) communication; and
sending, by the first user equipment, charging information of the ProSe communication to the network.

2. The method of claim 1, wherein the first user equipment sends the charging information when the peer to peer connection is released.

3. The method of claim 1, wherein the first user equipment sends the charging information in response to a request message received from a network node.

4. The method of claim 1, wherein the charging information may contain a duration of the ProSe communication.

5. The method of claim 1, wherein the charging information may contain an amount of data transferred during the ProSe communication.

6. The method of claim 1, wherein a data path of the peer to peer connection goes directly between the first user equipment and the second user equipment without via any network node.

7. The method of clam 1, further comprising: determining whether to send the charging information to the network based on an indicator included in system information of the network.

8. A method for reporting charging information by a first user equipment, the method comprising: establishing, by the first user equipment, a radio resource control (RRC) connection with a network and entering a RRC connection mode;
establishing, by the first user equipment, a peer to peer connection with a second user equipment for a proximity-based service (ProSe) communication;
releasing, by the first user equipment, the RRC connection and entering a RRC idle mode;
releasing, by the first user equipment, the peer to peer connection during the RRC idle mode; and
sending, by the first user equipment, charging information of the ProSe communication to the network after the first user equipment establishes a new RRC connection with the network.

9. The method of claim 8, wherein the first user equipment sends the charging information in response to a request message received from a network node.

10. The method of claim 8, wherein the charging information may contain a duration of the ProSe communication.

11. The method of claim 8, wherein the charging information may contain an amount of data transferred during the ProSe communication.

12. The method of claim 8, wherein a data path of the peer to peer connection goes directly between the first user equipment and the second user equipment without via any network node.

13. The method of clam 8, further comprising: determining whether to send the charging information to the network based on an indicator included in system information of the network.

14. A communication device for reporting charging information by a first user equipment, the communication device comprising:
a control circuit;
a processor installed in the control circuit;
a memory installed in the control circuit and operatively coupled to the processor;
wherein the processor is configured to execute a program code stored in memory to report charging information by the first user equipment by:
establishing, by the first user equipment, a radio resource control (RRC) connection with a network and entering a RRC connection mode;
establishing, by the first user equipment, a peer to peer connection with a second user equipment for a proximity-based service (ProSe) communication; and
sending, by the first user equipment, charging information of the ProSe communication to the network.

15. The communication device of claim 14, wherein the first user equipment sends the charging information when the peer to peer connection is released.

16. The communication device of claim 14, wherein the first user equipment sends the charging information in response to a request message received from a network node.

17. The communication device of claim 14, wherein the charging information may contain a duration of the ProSe communication.

18. The communication device of claim 14, wherein the charging information may contain an amount of data transferred during the ProSe communication.

19. The communication device of claim 14, wherein a data path of the peer to peer connection goes directly between the first user equipment and the second user equipment without via any network node.

20. The communication device of claim 14, wherein the program code further comprises:
determining whether to send the charging information to the network based on an indicator included in system information of the network.
